(19) United States
(12) Patent Application Publication
(10) Pub. No.: US 2002/0101158 A1
(43) Pub. Date: Aug. 1, 2002

(54) Lamp and getter for removing gaseous impurities

(76) Inventors: Murli Theegala, Chino Hilis, CA (US); Holger Claus, Lake Forest, CA (US)

Correspondence Address: J. D. Harriman II, COUDERT BROTHERS LLP, 23rd Floor, 333 South Hope Street, Los Angeles, CA, 90071, US

(21) Appl. No.: 10/011,268

(22) Filed: Nov. 7, 2001

Related U.S. Application Data
(60) Provisional application No. 60/246,638, filed on Nov. 7, 2000.

(51) Int. Cl. H01K 1/54; H01J 17/24; H01J 19/70

(52) U.S. Cl. 313/557; 313/553

(57) ABSTRACT

The present invention has a lamp/getter assembly which reduces or eliminates mechanical and chemical wearing of the filament/leads in a lamp. One or more getters are formed across the filaments of the lead wires of a lamp during construction. During the cooking and sealing off process, the mechanical integrity of the lead wire/filament geometry is maintained by the effect of the getter structure. After the sealing process, the lamp is operated at lower than operating voltage and the getters operate to remove impurities. When the lamp is then operated at normal voltage and temperature, the getter melts and breaks.

This application claims priority of U.S. Provisional Application No. 60/246,638, filed on Nov. 7, 2000.

### BACKGROUND OF THE INVENTION

1. Field of the Invention

The present invention relates to a lamp and a getter for removing gaseous impurities from the lamp.

Portions of the disclosure of this patent document contain material that is subject to copyright protection. The copyright owner has no objection to the facsimile reproduction by anyone of the patent document or the patent disclosure as it appears in the Patent and Trademark Office file or records, but otherwise reserves all copyright rights whatsoever.

2. Background Art

During the construction of incandescent lamps, there are processes that can limit the operational performance and/or the life of the lamp. One such process is referred to as cooking and sealing and is used to seal the components of a lamp in a glass envelope, such as a bulb. This step can put mechanical stress on the filament that can have detrimental effects on lamp performance. This problem can be better understood by a review of incandescent lamps.

Incandescent lamps are devices that produce light by heating a suitable material to a high temperature. When any solid or gas is heated (commonly by combustion or resistance to an electric current) it gives off light of a color which depends on the spectral balance characteristic of the material. An incandescent lamp is a source of illumination consisting of a glass bulb filled with an inert gas at low pressure and containing a finely wound metal filament (e.g. tungsten, osmium, tantalum, or others). When current is passed through the filament, it heats up (attaining temperatures of up to 2,500° C.) and emits intense visible light. (An incandescent lamp is sometimes informally referred as “bulb” or “light bulb” because the envelope that contains the gas and filament is made of a glass bulb).

An incandescent lamp is typically constructed out of a glass bead, a glass envelope, lead wires, and a filament. FIG. 1A is an illustration of an incandescent lamp. The lamp consists of a glass bead 101, a glass envelope 102, (often referred to as the “bulb”) two lead wires 103, and a filament 104. The glass bead 101 is a thick circular base of an incandescent lamp. A pair of lead wires 103 pass through the glass bead 101 to connect with the electrical power lines 105 (in some embodiments, the base of the lamp has a screw in attachment for coupling the lamp to a power source). The filament 104 is the wire inside of the bulb, glass envelope 102, attached between the top of the two lead wires 103.

The glass envelope 102 is filled with gas mixture 106 at low pressure. The gas mixture 106 is inert in nature. The power lines 105 and lead wires 103 are made with conductive material such as copper. The filament 104 is made of material that resists the flow of current. A typical incandescent lamp contains a double-wound filament. A double wound filament is a very fine filament wire that is first wound into a long, thin spiral and then this spiral is again wound into a wider spiral. While the final filament wire looks about 1 or 2 centimeters long, it actually contains about 1 meter of fine filament. When electricity runs through the filament 104, it heats it to over 2,500° C., causing the filament 104 to give off light.

The glass envelope 102, or bulb, is the clear “shell” around the filament 104. It's purpose is to keep air away from the filament 104 so that the filament doesn't oxidize and destroy itself. There are two types of incandescent lamps—vacuum and gas filled. The gases used in a gas filled lamp are inert gases such as Argon, Krypton, Xenon, and Halogen.

One step in current lamp manufacturing techniques is the removal or elimination of impurities inside the glass envelope. In spite of efforts at eliminating them, impurities may remain inside a lamp after the gas filled lamp is completed and sealed off. These impurities can include gaseous impurities 107 like hydrogen, oxygen, and nitrogen. These impurities 107 decrease the performance of the lamps in terms of average life, brightness and premature failures.

Many lamp manufacturers use some form of “getter” material to clean up those gaseous impurities. The getter is a material that has an affinity for impurities such as oxygen and nitrogen. During operation, the getter material draw such impurities to itself, keeping them away from the filament wire. There are a number of ways to implement a getter in prior art lamps. In some schemes, the getter material is painted on the lead wires themselves. In other circumstances, a separate getter structure is formed in the lamp.

FIG. 1B is an illustration of an incandescent lamp that includes a separate getter 108. Getter 108 is a metallic disc which is coated with a material (e.g., Barium) which has high affinity for oxygen and nitrogen. The getter 108 is welded or otherwise attached to one of the lead wires 103 as shown in FIG. 1B.

In addition to the chemical reactions that can shorten filament life span, mechanical forces can also act to damage or stress the filament, further reducing its life span. The lamp is constructed by causing the lead wires to protrude through a glass bead. Then, a glass envelope is placed on top of the glass bead and cooked to create a seal. This cooking and sealing step can have a detrimental mechanical effect on the filament of the lamp.

This mechanical effect is illustrated in FIGS. 2A and 2B. FIG. 2A illustrates lead wires 202 protruding through a glass bead 201, a getter 203 welded to one of the lead wires 202 and a filament 204 across to the top ends of the lead wires 202. The initial length of the filament 204 is noted to be L₀.

During the cooking operation, the lamp structure is as shown in FIG. 2B. The heat during this operation can cause expansion of the leads 202, actually changing their length as shown by leads 202′. This in turn widens the gap between the ends of the filament 204, increasing its length to L1, as shown by filament 204′ of FIG. 2B. The stretching of the filament builds up a stress within the filament 204′. This stress can eventually cause the filament 204′ to break apart at high temperature. Even if the filament is not weakened to the point of premature breaking, the stretching can cause reduced illumination of the lamp. Hence the stretching of the filament decreases the life span of the filament and/or reduces lamp performance.

FIG. 3 shows a broken filament 301 after a repeated cycle of operation of an incandescent lamp. The chances of breaking the filament is tremendously increased by the stretching of the filament caused when the glass envelope is cooked and sealed, and the expansion of the parts during operation of the lamp.

### SUMMARY

The present invention has a lamp/getter assembly which reduces or eliminates mechanical and chemical wearing of the filament/leads in a lamp. One or more getters are formed across the filaments of the lead wires of a lamp during construction. During the cooking and sealing off process, the mechanical integrity of the lead wire/filament geometry is maintained by the effect of the getter structure. After the sealing process, the lamp is operated at lower than operating voltage and the getters operate to remove impurities. When the lamp is then operated at normal voltage and temperature, the getter melts and breaks.

### BRIEF DESCRIPTION OF THE DRAWINGS

These and other features, aspects and advantages of the present invention will become better understood with regard to the following description, appended claims and accompanying drawings where:

FIG. 1A is a diagram of a typical incandescent lamp.

FIG. 1B is a diagram of an incandescent lamp with a getter.

FIG. 2A is a diagram of an incandescent lamp before the glass envelope is cooked and sealed.

FIG. 2B is a diagram of an incandescent lamp after the glass envelope is sealed off.

FIG. 3 is a diagram of an incandescent lamp with a broken filament after a repeated cycle of operation of an incandescent lamp.

FIG. 4 is a diagram of the invention, an incandescent lamp with special getter arrangement.

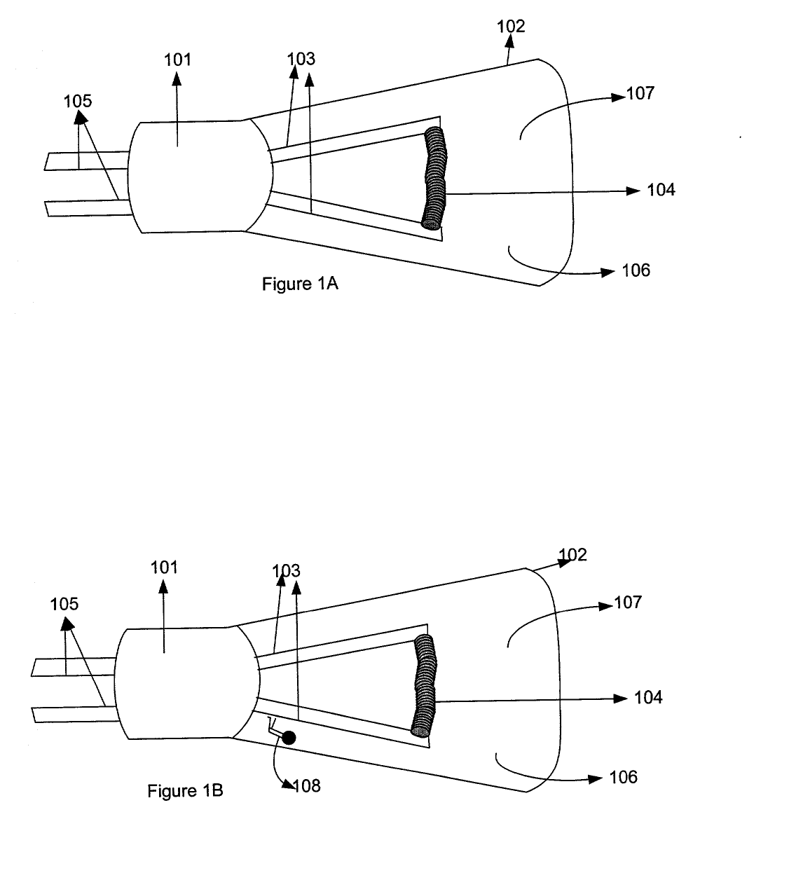

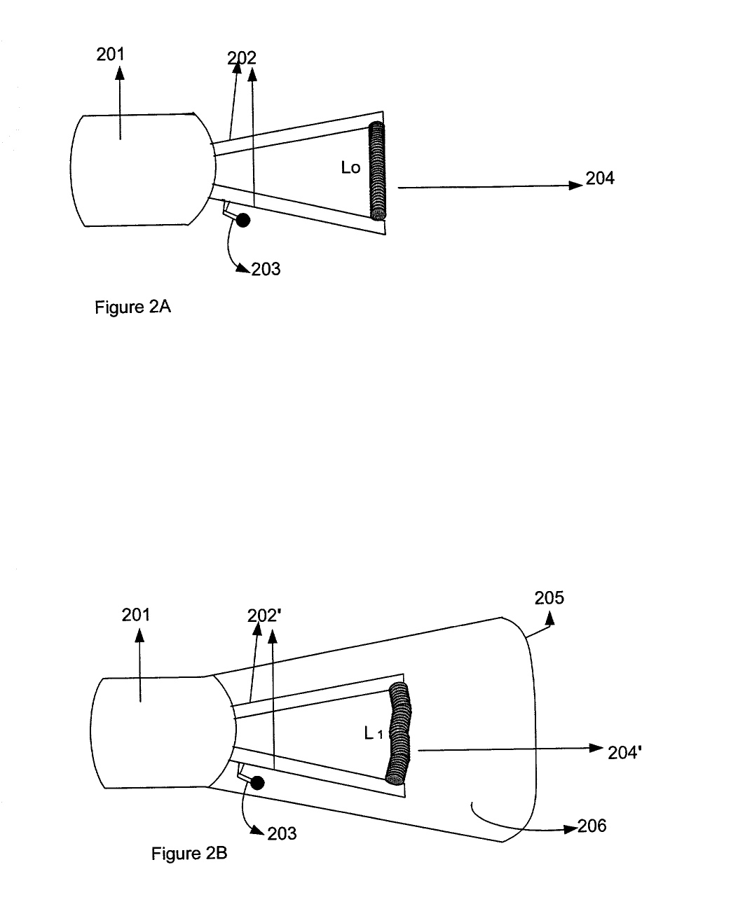

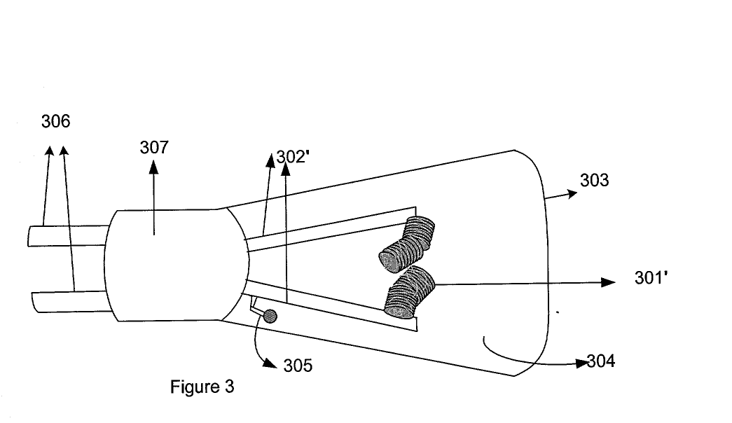

### DETAILED DESCRIPTION OF THE INVENTION

A lamp/getter assembly is described. In the following description, numerous details are set forth in order to more thoroughly describe the present invention. It will be apparent, to one skilled in the art, that the present invention may be practiced without these specific details. In other instances, well know features have not been described so as not to unnecessarily obscure the present invention.

The present invention provides a lamp/getter assembly that both reduces chemical wear on the filament and mechanical wear as well. The invention replaces the separate getter with a getter coupled across the lead wires of the lamp. The getter then provides mechanical strengthening of the lead/filament assembly during the cooking and sealing phase to reduce or eliminate mechanical stress on the filament geometry during lamp construction and operation.

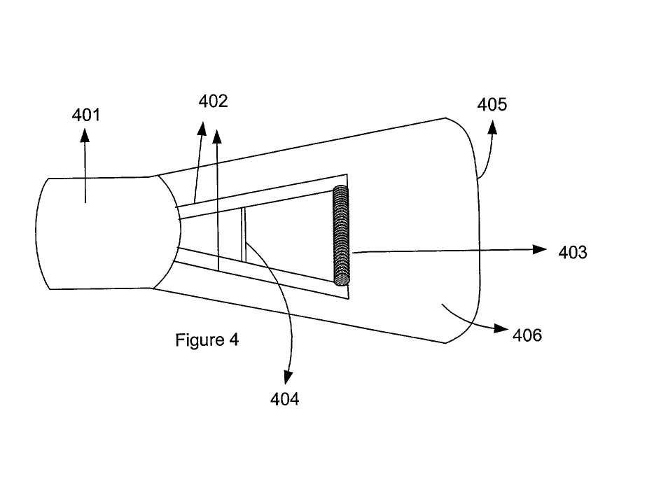

FIG. 4A is an illustration of the invention, with lead wires 402 formed through a glass bead 401. The filament 403 and getter 404 are then welded to the lead wires 402. The getter 404 is welded across the two lead wires approximately midway between the filament and the bead. In one embodiment, the getter 404 is a zirconium wire. In another embodiment, the getter 404 is a titanium wire or may be comprised of tantalum titanium. The getter is usually of a small diameter. In one embodiment, the diameter of the wire is less than 0.005 inches. Then, a glass envelope 405 is placed on top of the glass bead 401 and cooked to create a seal.

During lamp cooking and sealing operation, the getter 404 prevents the spreading of the lead wires 402, preventing stretching of the filament and the corresponding mechanical stress and lowered performance that can result.

After the sealing operation, the lamp is operated in an initial low voltage state to permit the gettering to occur. In one embodiment, an initial voltage of less than 2 volts and length of time of less than 5 minutes is used. This embodiment causes the zirconium getter to heat to about 1000° C. allowing it to getter almost all the gaseous impurities from the lamp. After this first stage, the voltage of the lamp is increased to the rated voltage, which lights the filament of the lamp and melts and breaks the zirconium wire.

In another embodiment, multiple getter wires may be used, which may be of differing compositions. Different getter wire compositions show different affinities for gettering different gaseous impurities. Thus, multiple different getter wires enhance the ability to getter various different gaseous impurities within the same sealed glass envelope, while providing structural protection of the lead wire/filament geometry during construction.

Without the support provided by the getter, the filament stretches during the lamp seal off process. This stretching affects lamp performance in terms of decreased brightness. The net result of the invention is more consistent lamps in terms of performance and increase in yields (50% more) than regularly made lamps without such getter support.

The present invention has an excellent arrangement of a getter within an incandescent lamp. The material which is used as a getter works effectively below the rated voltage of the lamp and removes almost all the impurities within the glass envelope. This increases the life span of an incandescent lamp by 50%. The fashion of the getter arrangement across the lead wires prevent the stretching of the filament in an incandescent lamp. This improves the life span of an incandescent lamp.

1. A lamp, comprising:
a sealed chamber comprising a translucent material;
a first and second lead wire protruding into said chamber;
a filament coupled to said first and second lead wires; and
a getter coupled to said first and second lead wires.

2. The lamp of claim 1, wherein said getter is zirconium.

3. The lamp of claim 1, wherein said getter is tantalum titanium.

4. The lamp of claim 1, wherein said getter is disposed approximately midway on said first and second leads.

5. A method of constructing a lamp comprising:
forming a lamp assembly comprising a glass bead, first and second lead wires, first and second power wires, a filament formed between said first and second lead wires, and a glass envelope;
forming a getter assembly coupled across said first and second lead wires;
cooking and sealing said lamp assembly;
applying a first voltage to said assembly to activate said getter;
applying a second voltage to said lamp assembly to melt and break said getter.

6. The method of claim 5 wherein said getter assembly comprises zirconium.

7. The method of claim 5 wherein said getter assembly comprises titanium.

8. The method of claim 5 wherein said getter assembly comprises is formed approximately midway on said first and second leads.

9. The method of claim 5 wherein said first voltage is lower than an operating voltage of said lamp.

10. The method of claim 9 wherein said first voltage comprises approximately 2 volts applied for approximately two minutes.

11. The method of claim 5 wherein said second voltage is an operating voltage of said lamp.

12. The method of claim 5 further including forming a plurality of getter assemblies across said first and second lead wires.

13. The method of claim 12 wherein said plurality of getter assemblies each comprise a different getter material.
